(19) United States
(12) Patent Application Publication
(10) Pub. No.: US 2010/0245775 A1
(43) Pub. Date: Sep. 30, 2010

(54) MINIATURISED PROJECTION DEVICE USING AN LED ARRAY AND DICHROIC WEDGE

(76) Inventors: Peter Rubinshtein, South Australia (AU); Danny Jung, South Australia (AU)

Correspondence Address: BIO INTELLECTUAL PROPERTY SERVICES (BIO IPS) LLC, 8509 KERNON CT., LORTON, VA, 22079, US

(21) Appl. No.: 12/745,921

(22) PCT Filed: Dec. 3, 2008
(86) PCT No.: PCT/AU2008/001784

§ 371 Date: Jun. 3, 2010

(30) Foreign Application Priority Data
Dec. 3, 2007 (AU) AU2007906553

(51) Int. Cl. G03B 21/28

(52) U.S. Cl. 353/31

(57) ABSTRACT

The present invention relates to an image projection device having a linear array of LED's in a common substrate, a common lens group to collimate light from each LED, and a single dichroic wedge having dichroic coatings for reflecting each light source to a condensing means which condenses the light to a distal surface. The image projection device therefore provides for a smaller optical package which is more easily accommodated in mobile devices such as mobile telephones, and which is simple and cheap to manufacture.

### FIELD OF THE INVENTION

The present invention relates to a miniaturised projection device and, in particular, to a device in which a projected image is provided by the use of a plurality of light sources and a dichroic wedge having surfaces adapted to reflect each light beam separately, the angle of the wedge being adjustable to facilitate controlled mixing of the light beams.

### BACKGROUND OF THE INVENTION

Image projection apparatus have been known for a number of years and fall into two distinct categories, the rear projection, and forward projection types. For example, a conventional television receiver is a rear projection apparatus, whilst a conventional cinema projector is a forward projection apparatus. Currently known projectors have a number of difficulties and limitations.

The first of these is that all projection apparatus require sophisticated and complex optical engines and electronic components that are in-built into the apparatus. Frequently the apparatus contain LCD or DLP technologies, or cathode ray tube technology, that requires precision optics to function. The complex optical engines increase the cost of these projectors, and due to their size are often not able to be applied to miniaturised projectors for example in hand held devices. Furthermore, they are quite fragile and can be easily damaged or misaligned. They are also typically cumbersome and are not intended to be truly portable apparatus.

For some of the reasons mentioned above, projection apparatus need to be carefully stored and moved and are therefore unsuitable for displaying images in portable environments.

The applicant is the owner of co-pending patent applications AU2006906179 and AU2006906180 which relate to optical engines that overcome some of the aforementioned problems in that they provide a self-contained optical engine design adapted for use in portable devices and miniaturised projection systems.

Although effective, these devices still suffer from some drawbacks including their complexity, the fact that multiple components are required consuming a lot of space within the device making them less suitable for miniaturised units, and as a result, their overall size and expense. Any means of reducing the number of parts in optical engines is beneficial in terms of light loss, miniaturisation, their cost, and their overall ruggedness, that is, their portability.

It is therefore an object of the present invention to provide a miniaturised projection device that overcomes at least some of the aforementioned problems or provides the public with a useful alternative.

It is a further object of the present invention to provide a miniature projection system having a linear array of LED sources, a single collimating lens group and stacked dichroic mirrors, the angle and thickness of the wedged mirrors being chosen to superimpose the LED sources.

It is a yet further object of the present invention to provide a miniaturised projection device that requires only 2 axis optics.

It is a still further object of the present invention to provide a miniaturised projection system that is less complex and which contains less optical components than hitherto known systems.

### SUMMARY OF THE INVENTION

Therefore in one form of the invention there is proposed an image projection device characterised by:

at least two light sources of different wavelength;

a means of collimating light from each of said at least two light sources;

a dichroic wedge having a plurality of reflective surfaces, whereby each reflective surface is adapted to reflect light from each one of the collimated light sources in the same direction; and

a means of condensing light reflected from the dichroic wedge to a distal surface.

Preferably the at least two light sources are arranged in a linear array on a common substrate.

In preference said means of collimating light from each one of said at least two light sources is a single collimating lens group for all the light sources.

In preference the angle of the dichroic wedge relative to the light sources is adjustable.

Preferably the image projection device includes three light sources arranged in a linear array on a common substrate.

In preference said three light sources are red, green and blue LED's.

Alternatively the image projection device includes two light sources positioned in a proximate linear arrangement, and a third light source positioned behind the dichroic wedge.

Preferably the three light sources are red, green and blue LED's.

In preference the image projection device further includes a light modulator such as a liquid crystal display (LCD) or liquid crystal on silicon (LCOS), which is illuminated with light from said condensing means.

Preferably the image projection device further includes an objective and projection lens positioned between the light modulator and the distal surface.

In preference the condensing means is in the form of one or more condensing lenses.

Preferably all of said lenses include an antireflection coating to minimise reflection.

In preference said image projection device includes means to dissipate heat from the optical elements.

In preference said image projection device is used to project an image from a mobile device.

In a further form of the invention there is proposed an image projection device characterised by:

a blue, green and red light emitting diode arranged in a linear array on a common substrate;

a single collimating lens group adapted to collimate light from each of the light emitting diodes;

a wedge having three dichroic coatings arranged to reflect said collimated light from each of the light emitting diodes in the same direction;

at least one condensing lens for condensing light reflected from the wedge to a distal surface;

a light modulator such as a LCD panel illuminated with light from said at least one condensing lens; and

objective and projection lenses positioned between the light modulator and the distal surface.

In a still further form of the invention there is proposed a mobile device such as a mobile telephone, including an image projection device as characterised above.

In having a linear array of LED's, a common lens group to collimate each LED, and a wedge having different dichroic coatings for reflecting each light source, the image projection device of the present invention allows for a smaller optical package, and one which is more simple and cheap to manufacture in comparison with hitherto known devices of this type.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings:

FIG. 1a illustrates a top, cross-sectional view of the miniature projection system of the present invention and, in particular, the path of blue light;

FIG. 1b illustrates a top, cross-sectional view of the miniature projection system of the present invention and, in particular, the path of green light;

FIG. 1c illustrates a top, cross-sectional view of the miniature projection system of the present invention and, in particular, the path of red light;

FIG. 2 illustrates a top, cross-sectional view of the housing of the projection system of FIGS. 1a-1c;

FIG. 3 illustrates the housing of the projection system of FIGS. 1a-1c from View A in FIG. 2;

FIG. 4 illustrates the housing of the projection system of FIGS. 1a-1c from View B in FIG. 2;

FIG. 5 illustrates the housing of the projection system of FIGS. 1a-1c from View C in FIG. 2;

FIG. 6 illustrates a side, cross-sectional view of the spacer of the projection system of FIGS. 1a-1c;

FIG. 7 illustrates a side-cross-sectional view of one of the retaining rings of the projection system of FIGS. 1a-1c;

FIG. 8 illustrates a perspective view of the LED bracket of the projection system of FIGS. 1a-1c;

FIG. 9a illustrates a front view of the focus block of the projection system of FIGS. 1a-1c;

FIG. 9b illustrates a side view of the focus block of FIG. 9a; and

FIG. 10 illustrates a top view of a mobile device having an in-built miniaturised projection system in accordance with the present invention.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention.

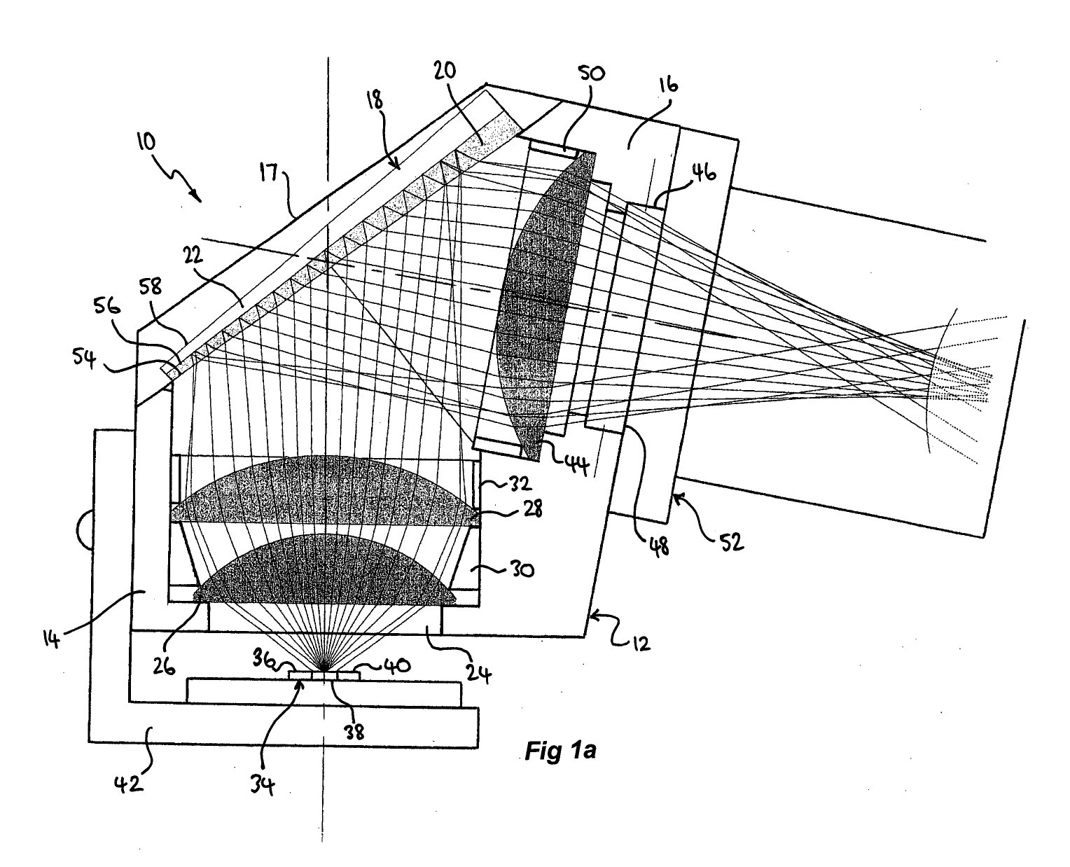

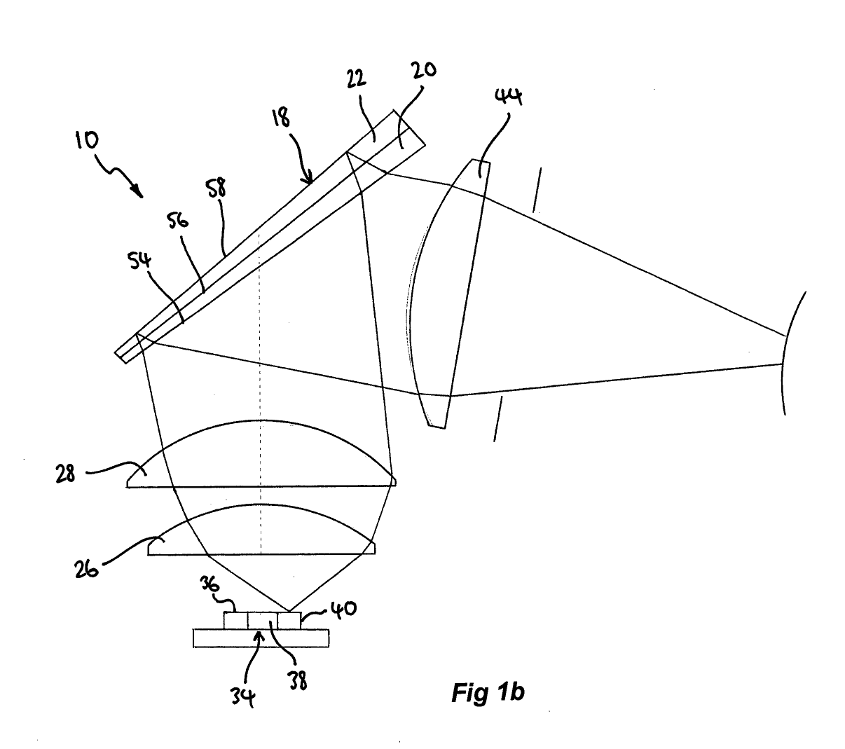

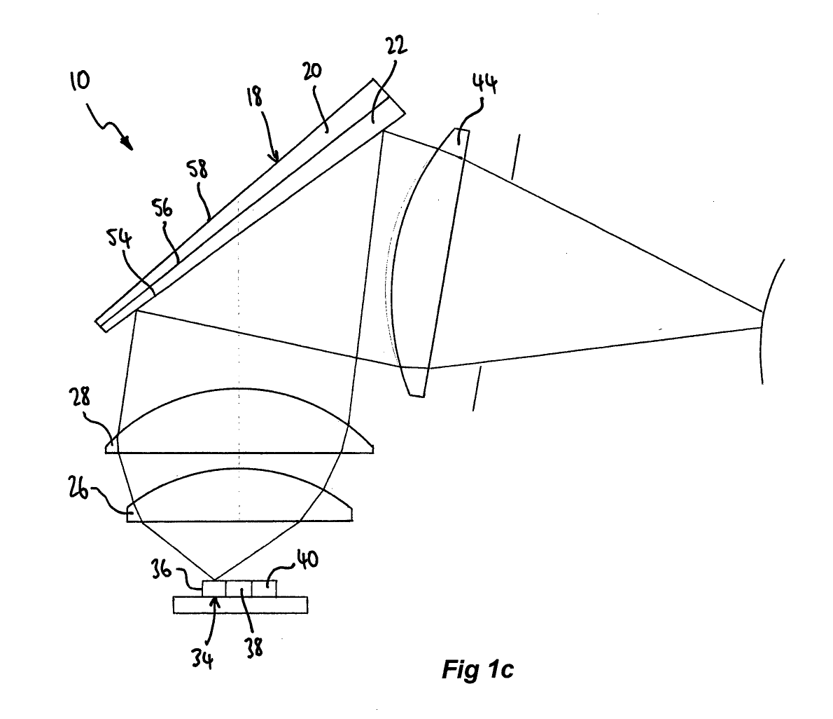

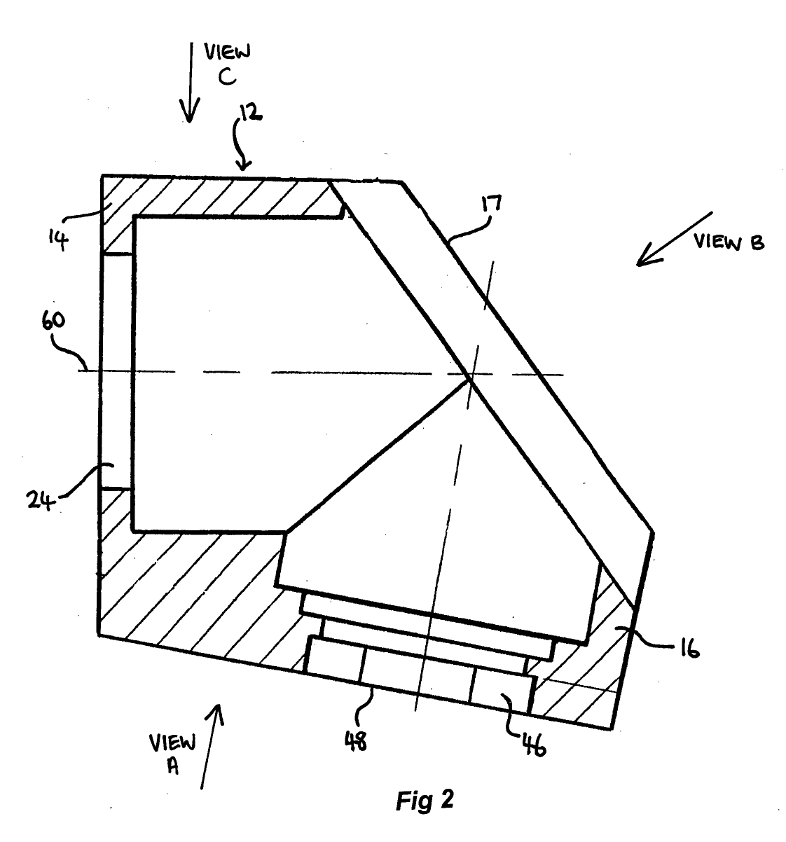

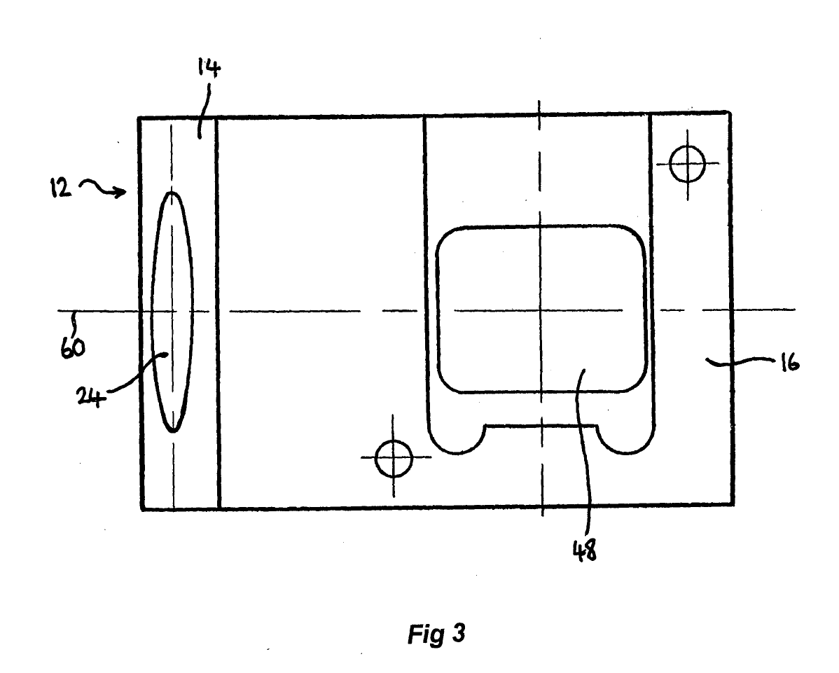

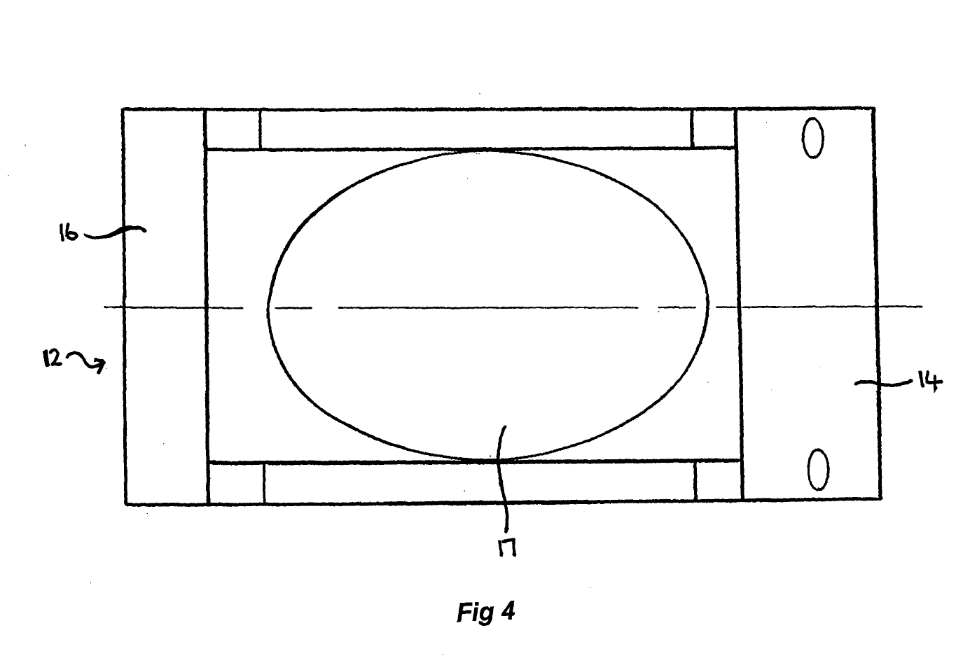

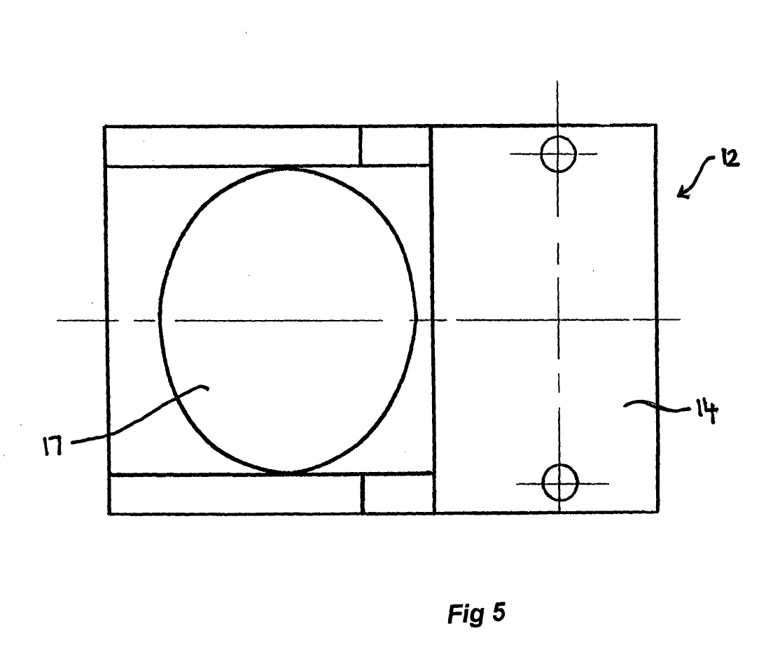

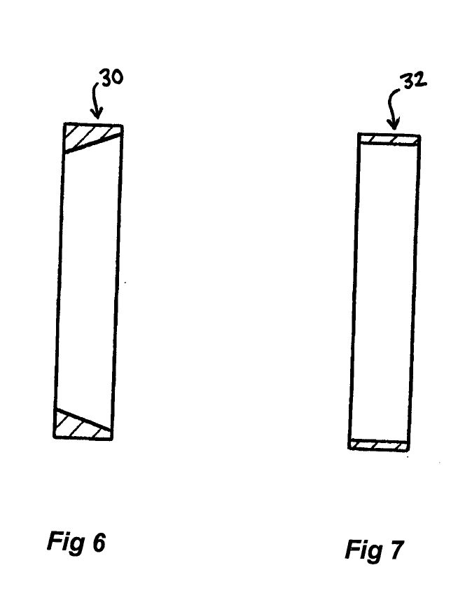

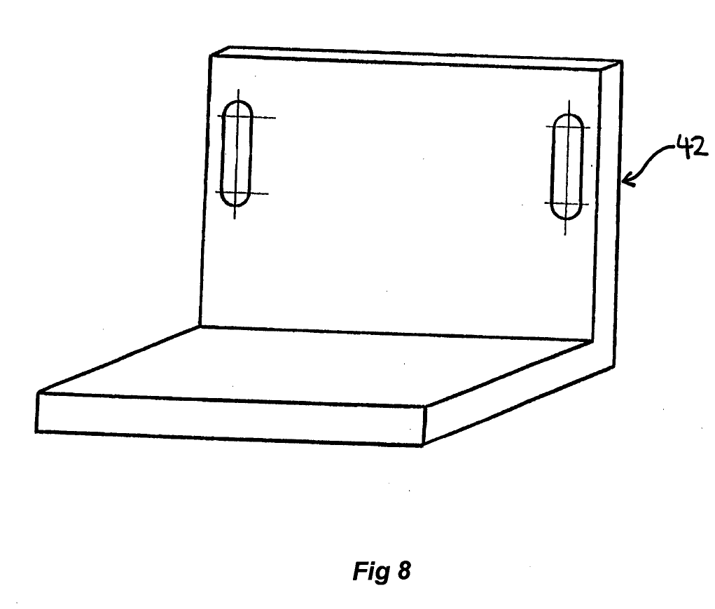

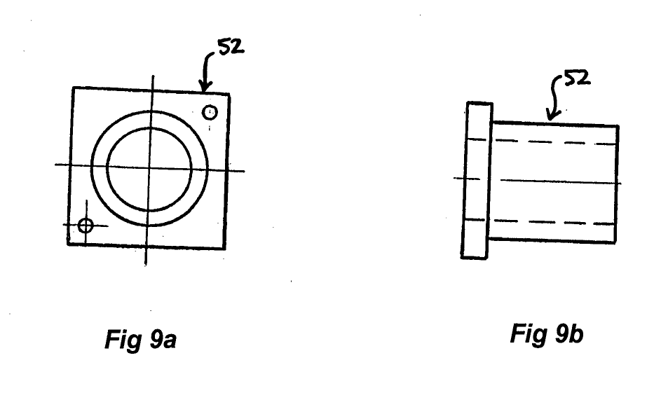

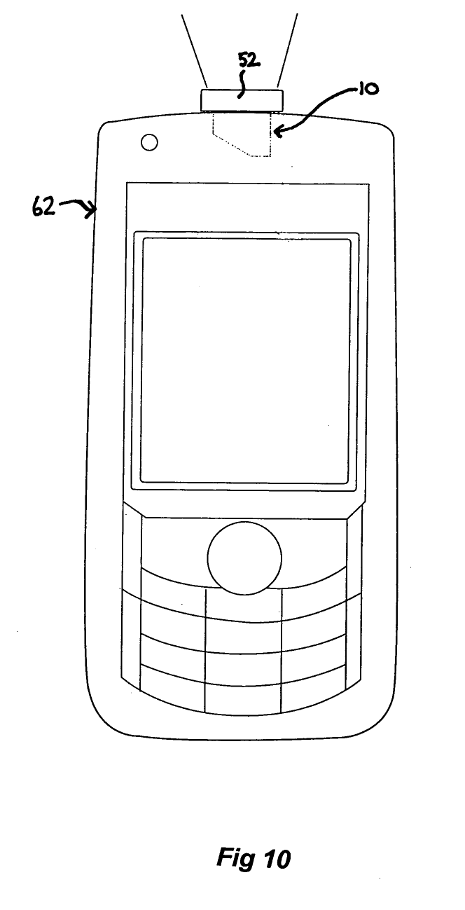

FIGS. 1a-1c illustrate the projection device 10 of the present invention, whilst FIGS. 2-9 illustrate separately the various components of the device 10. Although not shown, the device will normally form part of an optical engine comprising all the optical components necessary to construct and project an image from the projection device.

The device 10 includes a housing 12 having two main elongate sections 14 and 16 which extend at approximately 80 degrees relative to one another, the housing including a portion 17 extending across an apex thereof, configured to receive a dichroic wedge 18. In the embodiment shown, the dichroic wedge is made up of two stacked dichroic mirrors 20 and 22 of approximately the same size and shape. The dichroic wedge 18 is mounted so that its angle relative to incoming light is adjustable, this being described in further detail below.

The housing 12 is typically (but not essentially) made from aluminium because of its heat dissipation properties and its low weight (note that in embedded devices, the housing could utilise part of the existing device housing, which could be a plastic material). The first section 14 includes an inlet 24, a first collimating lens 26, a second collimating lens 28 spaced from the first lens 26 using a spacer 30, and a retaining ring 32 for retaining the second collimating lens 28 in position.

Light is sourced from a Light Emitting Diode (LED) plate 34 comprising three LED's 36, 38 and 40 positioned in a linear arrangement on the plate 34. The plate 34 is fixed onto an L-shaped bracket 42 which is mounted adjacent the inlet 24 of the housing 12 so that light is directed toward the first collimating lens 26. The bracket 42 is preferably adjustably mountable so that the distance between the LED's or any other individual colour light source and the first collimating lens 26 can be adjusted.

In the embodiment shown, the first LED 36 is red, the second LED 38 is blue, and the third LED 40 is green, and the intensity of each light source is adapted to be individually controlled. FIG. 1a shows the path of light from the blue LED 38, FIG. 1b shows the path of light from the green LED 40, and FIG. 1c shows the path of light from the red LED 36, however, this is for the purpose of clearly illustrating the paths of light. It is to be understood that all three light sources should be working at any one time.

The second section 16 houses a condensing lens 44 and, in the embodiment shown, a liquid crystal display (LCD) panel 46 adjacent an outlet 48 thereof. As mentioned, other light modulators such as an LCOS panel could equally well be used. A further retaining ring 50 is used to retain the condensing lens 44 in the position shown. Mounted to the outlet 48 is a focus block (not shown) which contains an objective or focussing lens (not shown) being adjustable so as to focus the image being projected. The objective lens may also be configured to receive or form an antenna for a mobile device which the projection device 10 may be used in conjunction with, as shown in FIG. 10.

The abovementioned lenses are preferably coated with an anti-reflection coating to minimise refraction and reflection and maximise the throughput of light emitted from the LED's.

As mentioned, the dichroic wedge 18 is made up of two stacked dichroic mirrors 20 and 22. The mirrors 20 and 22 are coated so that three surfaces 54, 56 and 58 of the mirrors allow only certain colours through. For example, the first surface 54, which is angled at approximately 54 degrees relative to an axis perpendicular to longitudinal axis 60 of the first housing section 14, is coated to reflect red light and transmit blue and green light. The second surface 56 which extends at an angle of approximately 56.4 degrees, is coated to reflect blue light and transmit green light. Finally, the third surface 58 which extends at an angle of approximately 58.8 degrees is coated to reflect any remaining light. Those skilled in the art would realise that the mirrors are wedged by approximately 2.4 degrees, hence the increase in angle of each reflective surface.

It is to be understood that the wedge angles and thicknesses are chosen to ensure that the red, blue and green light sources are superimposed at the LCD/LCOS both in a positional and an angular sense.

It can be appreciated that the blue light emanated from the LED 38 is collimated by lens 26 and 28 and then travels to the dichroic wedge 18 where it is reflected by the second surface 56. Similarly, green light from LED 40 is reflected by the third surface 58, and red light from LED 36 is reflected by the first surface 54. The light then passes through the condensing lens 44, through the LCD panel 46, and through the focus block 52 and projection lens (not shown) to be projected onto a distal surface for viewing.

The skilled addressee would realise that the present device 10 provides for three different coloured light sources to use one collimating lens group and a single dichroic wedge 18, having stacked mirrors configured to illuminate a light modulator. This differs from previously known devices which typically include a 2×2 matrix of LED's, or alternatively, individual LED's each with its own collimating optic and individual mirrors. The use of a linear array light source and stacked dichroic mirrors means that significantly less space is required in an optical engine incorporating this system, and also less components, which means the system may be used across more applications than previous systems, and at reduced cost.

It should be noted that this LED array and dichroic wedge arrangement can be used to illuminate a light pipe, lenslet array or any other homogenising optic used in projection devices.

In an alternate embodiment which is not shown, a single dichroic double sided mirror could be used and instead of there being three LED's positioned at the inlet, there could be two LED's instead, with the third LED placed behind the dichroic mirror so as to direct light directly to the condensing lens through the dichroic mirrors. In this situation, for example where the green LED is positioned behind the wedge, only one mirror would be required which has two reflective surfaces, one for reflecting only blue and the other for reflecting only red.

In yet another alternate embodiment which is not shown, a single dichroic double sided mirror could be used with two reflecting surfaces behind which a conventional mirror is positioned, the double sided dichroic mirror reflecting blue and red respectively and the conventional mirror reflecting all light passing through the dichroic mirror surfaces (primarily green light). This alternate configuration allows for retaining of the in-line LED's and single collimating lens.

As mentioned, the housing 12 is preferably constructed from a heat absorbing and heat dissipating material, such as aluminium, and is mechanically strong. The housing 12 must hold the optical components in perfect alignment to stop artefacts being induced into the projected image as any twisting or warping of the frame will result in a distorted image.

The ability to project transmitted images enables the projection device 10 to project detailed transmitted information on a much larger display than the screen embedded in a mobile device, giving the user the ability to more clearly view detailed information, such as satellite photographs from a GPS satellite.

A further embodiment of the present invention would be to replace the visible spectrum LED's with infra red LED's to provide an image projected in infra red. Such an image could only be seen by a user wearing infrared goggles and could be used for security, defence or similar purposes.

FIG. 10 illustrates the projection system used in a mobile phone 62. It can be appreciated that such a device 10 is intended to be miniaturised and could be configured for use within a variety of hand held devices. The projection system is designed so that it has no moving parts and as a result is rugged and robust and able to be adapted for use with portable devices such as these. Any moving parts or delicate circuitry would not be robust enough to withstand the stresses of being used with a portable device, that is typically stored in a user's pocket and which may be susceptible to hard knocks and other damage.

The projection system is also designed to maximise the amount of light captured by the LEDs resulting in a greater brightness of the projected image, a better uniformity of image, a better contrast ratio and a better centre to corner ratio of the projected image. The lens design can also capture up to 98% of the light generated from the LEDs and as a result lower power is required to maintain brightness of the image projected, making the device 10 suitable for low powered hand held devices.

In a still further embodiment, operation of the LCD panel and the LED's could be controlled using a printed circuit board (not shown). Power to the device may be fed into the circuit board via cables, and distributed to electronic circuitry.

The device 10 also has all its optical components in an almost perpendicular optical path, minimising costs, maximising efficiency of light transfer and minimising the number of components required. This design enables the device 10 to be considerably smaller than other projection devices and therefore adapted for use in a wider variety of applications. The reduced number of components and the arrangement of these components further ruggedises the device 10 and allows it to be used in more severe conditions.

In hitherto known miniature projection systems, the LED's are not aligned in a linear 1-dimensional arrangement, but typically in a 2-dimensional matrix type arrangement, for example, four LED's positioned in 2×2 matrix whereby two of the LED's are of the same colour. In using the device of the present invention, that is, three LED's positioned in a linear arrangement approximately 1-1.5 mm apart, only 2-dimensional optics are required.

The present invention is not however intended to be limited to the use of only linear LED's, for example, the three LED's could equally well be arranged in a 2-dimensional L-shaped arrangement, therefore requiring 3 axis optics.

In so far as the dimensions of the device are concerned, this is dependent on several factors, eg. LCD or LCOS panel size, light output required and dimensional constraints imposed by the specific application. In one application, it is envisaged that the housing is dimensioned to fit within a 26×26 mm square, each dichroic wedge being some 23 mm long and 16 mm wide, and having a maximum depth of some 1.4 mm.

The shape of the dichroic wedges (including but not limited to dimensions, angles and coatings) depends on the wavelength of the light sources and relative arrangement. Wedge angle depends on distances to light sources and between light sources.

In general terms, the dichroic wedge optical design is such that colour beams incident on mirrors at different angles, also reflect at different angles. The achievable result of this is that all (two or more) light beams become parallel and collimated when impinging on an image carrying panel through the condensing lens.

This “reflective” strategy can also be utilised with all types of reflective digital display panels to produce a clear image.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1-16. (canceled)

17. An image projection device characterised by:
at least two light sources of different wavelength;
a means of collimating light from each of said at least two light sources;
a dichroic wedge having a plurality of reflective surfaces, whereby each reflective surface is adapted to reflect light from each one of the collimated light sources in the same direction; and
a means of condensing light reflected from the dichroic wedge to a distal surface.

18. An image projection device as characterised in claim 17 wherein the at least two light sources are arranged in a linear array on a common substrate.

19. An image projection device as characterised in claim 17 wherein said means of collimating light from each one of said at least two light sources is a single collimating lens group for all the light sources.

20. An image projection device as characterised in claim 17 wherein the angle of the dichroic wedge relative to the light sources is adjustable.

21. An image projection device as characterised claim 17 wherein the image projection device includes three light sources arranged in a linear array on a common substrate.

22. An image projection device as characterised in claim 21 wherein said three light sources are red, green and blue LED's.

23. An image projection device as characterised in claim 17 wherein the image projection device includes two light sources positioned in a proximate linear arrangement, and a third light source positioned behind the dichroic wedge.

24. An image projection device as characterised in claim 23 wherein the three light sources are red, green and blue LED's.

25. An image projection device as characterised in claim 17 wherein the image projection device further includes a light modulator such as a liquid crystal display (LCD) or liquid crystal on silicon (LCOS), which is illuminated with light from said condensing means.

26. An image projection device as characterised in claim 25 wherein the image projection device further includes an objective and projection lens positioned between the light modulator and the distal surface.

27. An image projection device as characterised in claim 17 wherein the condensing means is in the form of one or more condensing lenses.

28. An image projection device as characterised in claim 17 wherein all of said lenses include an antireflection coating to minimise reflection.

29. An image projection device as characterised in claim 17 wherein said image projection device includes means to dissipate heat from the optical elements.

30. An image projection device as characterised in claim 17 wherein said image projection device is used to project an image from a mobile device.

31. An image projection device characterised by:
a blue, green and red light emitting diode arranged in a linear array on a common substrate;
a single collimating lens group adapted to collimate light from each of the light emitting diodes;
a wedge having three dichroic coatings arranged to reflect said collimated light from each of the light emitting diodes in the same direction;
at least one condensing lens for condensing light reflected from the wedge to a distal surface;
a light modulator such as a LCD panel illuminated with light from said at least one condensing lens; and
objective and projection lenses positioned between the light modulator and the distal surface.

16. A mobile device such as a mobile telephone, including an inbuilt image projection device as characterised in claim 17.
